(19) United States
(12) Patent Application Publication
(10) Pub. No.: US 2005/0254441 A1
(43) Pub. Date: Nov. 17, 2005

(54) Method and apparatus for efficiently allocating and deallocating interleaved data stored in a memory stack

(75) Inventors: Alan M. Levi, Swarthmore, PA (US); Douglas R. Castor, Norristown, PA (US); George W. McClellan, Bensalem, PA (US); Binish P. Desai, Collegeville, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/925,424

(22) Filed: Aug. 25, 2004

Related U.S. Application Data
(60) Provisional application No. 60/571,301, filed on May 14, 2004.

(51) Int. Cl. H04B 7/00; H04L 12/54

(52) U.S. Cl. 370/277; 370/412; 370/428

(57) ABSTRACT

A method and apparatus for efficiently allocating and deallocating interleaved data stored in a memory stack. The apparatus includes a processor and a memory including at least one memory stack. The processor receives and interleaves a plurality of data blocks. Each data block is allocated for a particular transport channel (TrCH) and has a designated transmission timing interval (TTI). The processor stores the interleaved data blocks in the memory stack based on the TTI of each data block, such that a data block having a larger TTI is allocated to the memory stack earlier and deallocated from the stack later than a data block having a smaller TTI. In one embodiment, the memory includes a first memory stack for common/shared uplink channels, a second memory stack for dedicated uplink channels, a third memory stack for common/shared downlink channels, and a fourth memory stack for dedicated downlink channels.

### CROSS REFERENCE TO RELATED APPLICATION

This application claims priority from U.S. provisional application No. 60/571,301 filed on May 14, 2004, which is incorporated by reference as if fully set forth.

### FIELD OF INVENTION

The present invention is related to storing and retrieving data stored in a memory. More particularly, the present invention is related to a method and apparatus for efficiently allocating and deallocating interleaved data stored in a memory stack.

### BACKGROUND

Interleaving is a process that is well known, to those of skill in the art, for improving the resistance to error when communicating data across a wireless interface. Many interleavers include a data buffer, which is an area of memory that temporarily holds data after interleaving or before deinterleaving.

Under third generation partnership project (3GPP) specifications, the data buffer in a first interleaver holds up to eight (8) radio frames of data output from the transmit (TX) transport processing. FIG. 1 shows an exemplary data block allocation in a data buffer 100 in accordance with the prior art. The data buffer 100 is typically divided into eight (8) equally-sized memory areas 105, 110, 115, 120, 125, 130, 135 and 140, which operate together as a circular buffer. During each 10 ms radio frame, one of the memory areas 105, 110, 115, 120, 125, 130, 135 and 140, is consumed by TX composite processing, thereby freeing the area for new data coming from a TX transport.

A data buffer manager (not shown) stores information regarding the locations of the memory areas 105, 110, 115, 120, 125, 130, 135 and 140, and maintains a count regarding the storage capacity currently allocated in each of the memory areas 105, 110, 115, 120, 125, 130, 135 and 140. A request for an allocation within the data buffer 100 to store data must specify a requested storage area size and an expiration time, which comprise data buffer management information. The expiration time is specified in radio frames relative to the current frame. The data buffer manager uses the data buffer management information to find an appropriate area for storing the data.

Memory pointers and associated functions that manage the data buffer are used for performing an interleaving process on the data. Memory pointers are used to point to the next available memory location of a contiguous segment of data at is utilized on a given frame. Memory fragmentation is a common problem that may be dealt with by simply over-sizing the data buffer 100.

A first interleaver memory is typically partitioned into eight (8) equally-sized segments, corresponding to up to eight (8) frames in which any newly arrived data can be utilized. A memory segment holds interleaved data corresponding to a single frame of data. For transmission, when a transport block set arrives, storage capacity is allocated in up to all eight segments immediately. During each of the subsequent eight frames, one memory segment is consumed and subsequently freed for use. For reception, as the data is received, the memory is allocated for each frame of a transport channel's transmission timing interval (TTI) for up to eight (8) frames. The memory is then freed all at once after the transport channel is decoded.

Universal terrestrial radio access (UTRA) standards specify a first interleaving step in processing data to be transmitted over a wireless air interface. The standards specify that encoded data may be buffered for up to 80 ms (eight (8) frames). In order to avoid memory fragmentation, storage of this data may require a memory eight (8) times the amount of data that arrives in a 10 ms frame. From the standards, it may be realized that eight (8) times the maximum amount of data that can arrive in 10 ms frame will never need to be stored in the first interleaver buffer at a given time. This restriction is noted in technical specification (TS) 25.306 as the number of simultaneous bits that can be received in coinciding TTIs.

Accordingly, there is a need for a new method and apparatus for optimizing memory allocation in a first interleaver buffer such that a large amount of memory is not required.

### SUMMARY

The present invention is a method and apparatus used in a wireless communication system for efficiently allocating and deallocating interleaved data stored in a memory stack. The apparatus may be an interleaver, a wireless transmit/receive unit (WTRU), a base station (i.e., Node-B), or an integrated circuit (IC). The apparatus includes a processor and a memory including at least one memory stack. The processor receives and interleaves a plurality of data blocks. Each data block is allocated for a particular transport channel (TrCH) and has a designated TTI. The processor stores the interleaved data blocks in the memory stack based on the TTI of each data block, such that a data block having a larger TTI is allocated to the memory stack earlier and deallocated from the stack later than a data block having a smaller TTI.

In one embodiment, the memory may include a first memory stack for common/shared uplink channels, a second memory stack for dedicated uplink channels, a third memory stack for common/shared downlink channels, and a fourth memory stack for dedicated downlink channels.

A data block received from a dedicated channel and a data block received from a common/shared channel may be stored in separate regions of the memory stack.

A data block received from an uplink channel and a data block received from a downlink channel may be stored in separate regions of the memory stack. Data blocks having the same TTI may be grouped together and be aligned.

The memory may include a write pointer and a read pointer used to indicate the location of a segment in the memory stack for executing writing and reading operations, respectively. As the data blocks are received by the processor, the memory stack may be allocated for each frame of a transport channel's TTI for up to eight frames.

### BRIEF DESCRIPTION OF THE DRAWINGS

A more detailed understanding of the invention may be had from the following description of a preferred example, given by way of example and to be understood in conjunction with the accompanying drawing wherein:

FIG. 1 shows an exemplary data block allocation in accordance with the prior art;

FIG. 2 is a block diagram of a first interleaver in accordance with the present invention;

FIG. 3 shows an exemplary allocation of data blocks in a stack in accordance with the present invention;

FIG. 4 shows data blocks stored in a stack in accordance with the present invention; and

FIG. 5 is a flowchart of a process including method steps for allocating and deallocating data in accordance with the present invention.

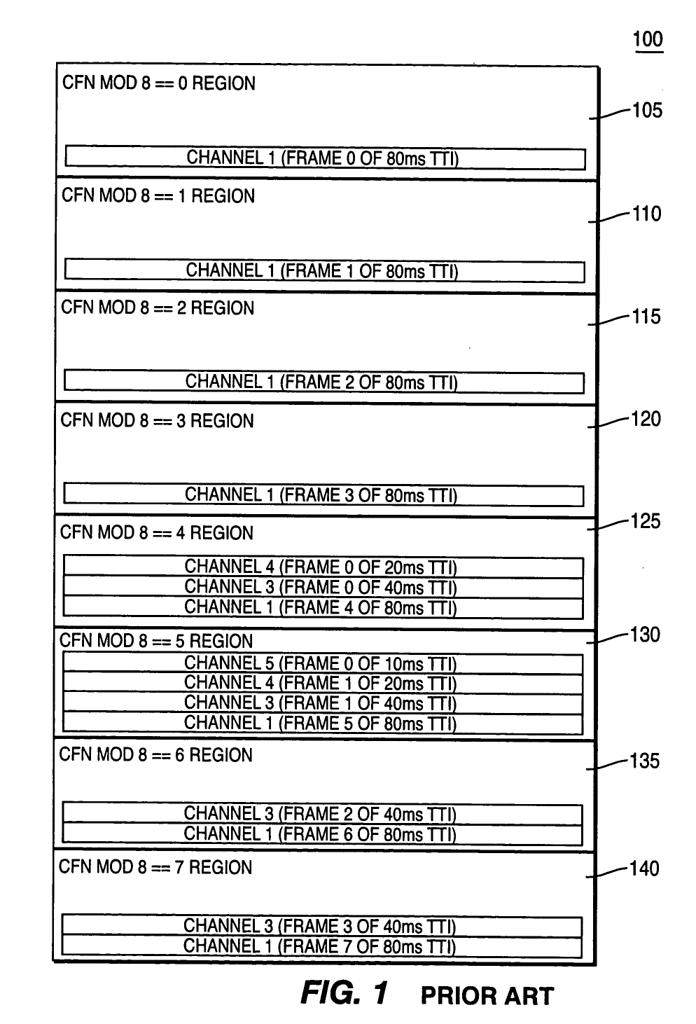

### DETAILED DESCRIPTION OF THE PREFERRED EMBODIMENTS

The present invention will be described with reference to the drawing figures wherein like numerals represent like elements throughout. The present invention may be implemented in both an interleaver and a de-interleaver. For simplicity, only an interleaver side will be explained hereinafter.

Hereafter, the terminology “WTRU” includes but is not limited to a user equipment (UE), a mobile station, a fixed or mobile subscriber unit, a pager, or any other type of device capable of operating in a wireless environment. When referred to hereafter, the terminology “Node-B” includes but is not limited to a base station, a site controller, an access point or any other type of interfacing device in a wireless environment.

The present invention may be applicable to Time Division Duplex (TDD), Frequency Division Duplex (FDD), and Time Division Synchronous CDMA (TDSCDMA), as applied to a Universal Mobile Telecommunications System (UMTS), CDMA 2000 and CDMA in general, but is envisaged to be applicable to other wireless systems as well.

The features of the present invention may be incorporated into an IC or be configured in a circuit comprising a multitude of interconnecting components. Furthermore, the present invention may be a process including a series of method steps implemented by running a series computer implemented instructions on a processor.

The present invention reduces the stack size of a first interleaver buffer by optimally organizing the stack for TrCH data segments. The optimization of the first interleaver buffer depends on the ability to process a TTI's worth of data from the first interleaver buffer in a 10 ms frame. All frame-rate components (software and hardware) are triggered to begin processing at or near the beginning of a 10 ms frame and must complete processing before the end of that same 10 ms frame. This ensures that extra frames of latency are not introduced and, therefore, helps to reduce the stack size requirement of the first interleaver buffer.

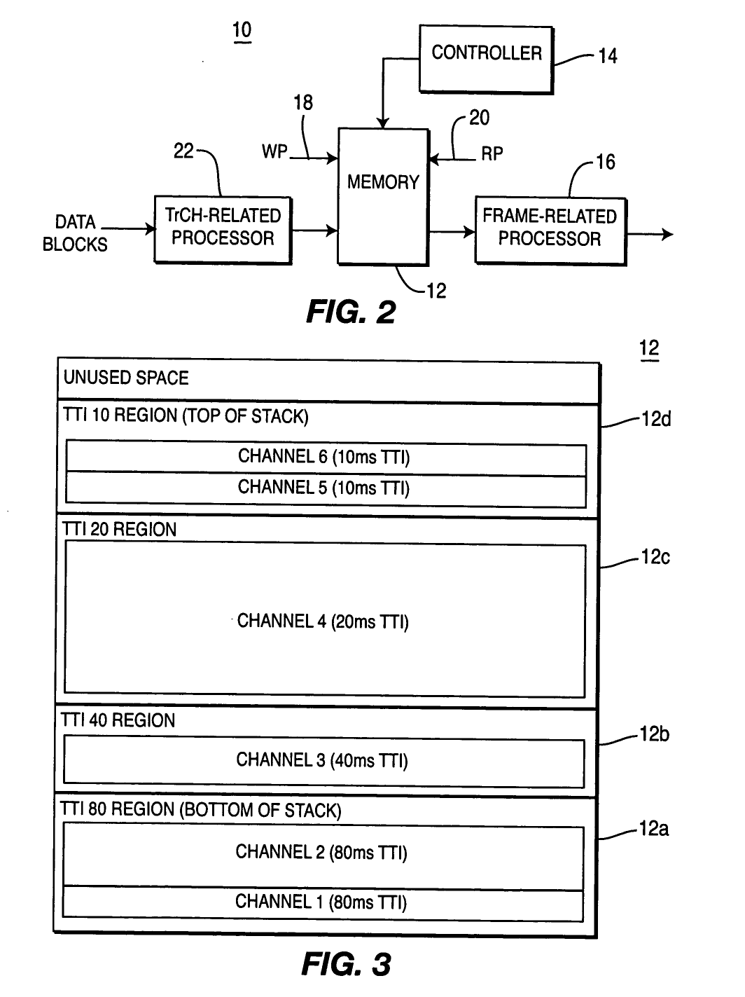

FIG. 2 is a block diagram of an interleaver 10 operating in accordance with the present invention. The interleaver may be incorporated in a WTRU and/or a Node-B of a wireless communication system. The interleaver 10 comprises a memory 12 including one or more stacks, a controller 14, a frame-related processor 16, and a TrCH-related processor 22. The memory 12 includes a write pointer (WP) 18, and a read pointer (RP) 20 used to indicate the location of a stack segment in a stack within memory 12 for executing writing and reading operations, respectively. The frame-related processor 16 retrieves data stored in a specific portion of the memory 12 as indicated by the read pointer 20.

Transport blocks from a plurality of channels are time aligned with each other. Dedicated channels (DCHs) are also aligned with each other. The DCHs may only start in a radio frame fulfilling the relation:
connection frame number (CFN) mod Fi=0, Equation (1) where Fi is the TTI value of TrCh “i”, from the set {1, 2, 4, 8}. Therefore, within a WTRU, all DCHs are aligned with each another.

Common channels are also aligned with each other. Common channels include a broadcast channel (BCH), a paging channel (PCH), a forward access channel (FACH), a random access channel (RACH), an uplink shared channel (USCH), and a downlink shared channel (DSCH). Common channels may only start in a radio frame fulfilling the relation:
system frame number (SFN) mod Fi=0, Equation (2) where Fi is the TTI value of TrCh “i”, from the set {1, 2, 4, 8}.

When higher layers inform layer 1 of a new channel configuration, the channel is identified as appropriate to the following four types: 1) common/shared; 2) dedicated; 3) uplink; or 4) downlink. The channel type is used to decide which stack a channel's first interleaved data is allocated in. There are preferably a total of four (4) stacks in memory 12. Two (2) separate stacks are provided for uplink and downlink processing respectively, and two (2) separate stacks are also provided for DCHs and common/shared channels, respectively. Therefore, one stack is provided for common/shared TX (uplink) channels, one stack for dedicated TX (uplink) channels, one stack for common/shared receive (RX) (downlink) channels, and one stack for dedicated RX (downlink) channels. Stacks for DCHs and common channels are provided separately because they are not necessarily aligned with each other.

FIG. 3 shows an exemplary allocation of data blocks in a stack of memory 12 in accordance with the present invention. Each group of transport blocks that have aligned TTI periods are assigned to the stack of memory 12.

A last-in, first out (LIFO) stack process is applied for the allocation and deallocation of the TrCH data blocks from each stack in memory 12. The data blocks are allocated and deallocated in the stack of memory 12 depending on the TTI of each data block.

A data block having a large TTI is allocated earlier and deallocated later than a data block having a small TTI. Therefore, an 80 ms TTI data block is allocated earlier and deallocated later than 40 ms, 20 ms and 10 ms TTI data blocks; and a 10 ms TTI data block is allocated later and deallocated earlier than 20 ms, 40 ms, and 80 ms data blocks. A 20 ms data block and a 40 ms data block are allocated and deallocated in a like manner. This enables stack optimization because, if two aligned transport channels with the same TTI are taken, then the lifetimes of their interleaved data begin and end in the same frame as each other. For example, transport blocks having a 40 ms TTI may start in every fourth frame in order to meet the TTI alignment restrictions. Therefore, the starting frame and the ending frame for a transport block having a 40 ms TTI fall in every fourth frame. This makes it efficient to group the transport blocks together into the same stack region.

Another reason why the present invention enables stack optimization is because the end of a transport channel's lifetime will always coincide with the lifetime of lower TTIs. For example, the interleaved data of a 40 ms TTI transport channel (channel A) begins in frame 1 and ends in frame 4 (inclusive). Another channel (channel B) with a 20 ms TTI must begin in an odd-numbered frame in order to guarantee TTI alignment restrictions. That is, channel B must begin in frame 1 or frame 3, or both. If channel B begins with frame 3, the lifetime of channel A coincides with the end point of channel B. Therefore, when channel A is deallocated, channel B is also deallocated from the stacks of memory 12 at the same time.

Common channels are not aligned with DCHs (i.e., it is not guaranteed that a 20 ms DCH will have the same start and end frames as a common channel with a 20 ms TTI). Therefore, physically pooling the bits of DCHs and common channels together in the same stack results in increased fragmentation. One way to resolve this problem is to use separate memories for common and dedicated channels. As explained previously, since the present invention preferably utilizes separate stacks for DCHs and common channels, each stack stores only transport blocks which are aligned with each other.

Alternatively, it is possible to limit the requirements for common/shared channels based on configurations known in advance. In particular, a forward access channel (FACH) has cases that never require the amount of data specified in the restriction noted in TS 25.306 as to the number of simultaneous bits that can be received in coinciding TTIs. The cases provide a more strict restriction on the amount of data that a WTRU or a Node-B must be able to process and, therefore, allow a reduction in size of the first interleaver buffer stacks.

Referring to FIG. 3, there are six channels, Channel 1 through Channel 6, having data blocks to be transmitted. These channels are TTI aligned. Therefore, they are either all common channels or are all dedicated channels. Data blocks of channels 1 and 2 have an 80 ms TTI; a data block of channel 3 has a 40 ms TTI; a data block of channel 4 has a 20 ms TTI; and data blocks of channels 5 and 6 have a 10 ms TTI. The data blocks of channels 1 and 2 are allocated first in a first region 12a, which is designated as being the “bottom” (i.e., the first allocated place in context of a LIFO process), of the stack of memory 12, because they have the largest TTI. Next, a data block of channel 3 is allocated in a second region 12b which is adjacent to the region 12a in the stack of memory 12. A data block of channel 4 is allocated in a third region 12c, and data blocks of channels 5 and 6 are allocated in a fourth region 12d, which is the “top portion” (i.e., the last allocated place in context of a LIFO process) of the stack of memory 12. Although the four regions 12a-12d have been specifically set forth herein, it should be understood by those of skill in the art that any number of regions, either greater or lesser, may be implemented.

Data blocks are deallocated in the opposite order from allocation of the stack of memory 12. Data blocks having the same TTI are grouped together to be allocated contiguously in the same region of the stack of memory 12, and deallocated at the same time from the stack of memory 12. As shown in FIG. 3, there is room left at the top portion of the stack of memory 12 to indicate that less than 100% of the available storage capacity is used in this example. In a worst case, the entire stack storage capacity would be used.

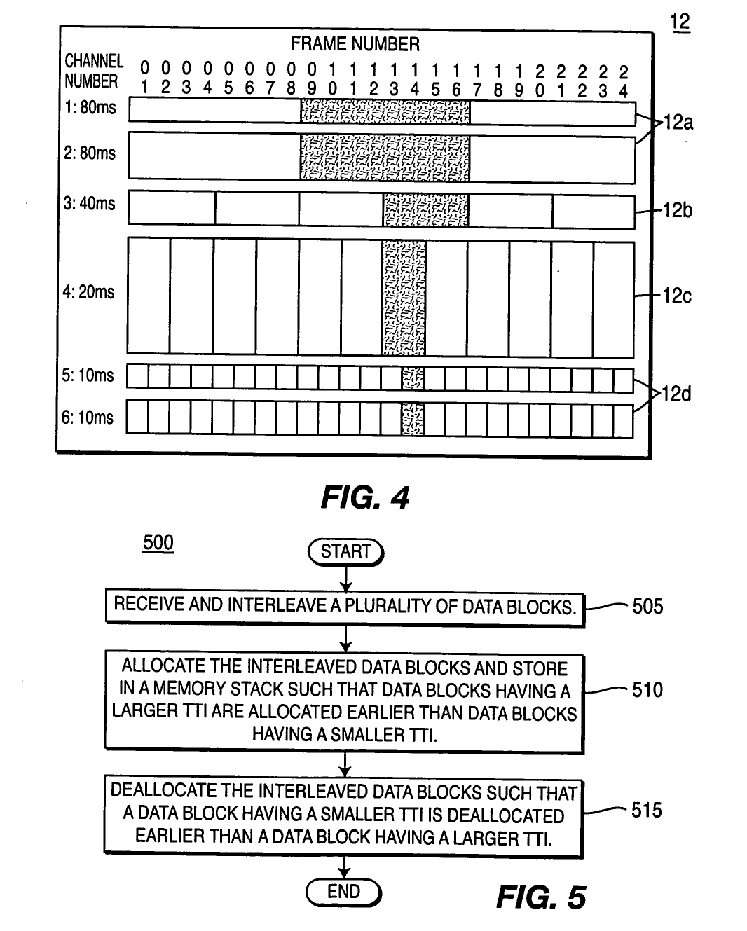

FIG. 4 depicts the lifetime of transport blocks of FIG. 3 as they are allocated in the stack of memory 12. More particularly, FIG. 3 is a snapshot of a stack of memory 12 during frame 14 of FIG. 4. Each block in FIG. 4 represents one TTI length of data that must be allocated for a particular transport channel. Transport blocks of channels 1 and 2 have been allocated in region 12a at frame 9; transport blocks of channel 3 have been allocated in region 12b at frame 13; transport blocks of channel 4 have been allocated in region 12c at frame 13; and transport blocks of channels 5 and 6 have been allocated in region 12d at frame 14. The data for channels 4, 5 and 6 have the same end point, (frame 14), and will be deallocated from the stack of memory 12 at the end of frame 14. At that time, it is possible that their configurations will change or that new 20 ms or 10 ms TTI channels may be added. It is not possible for a new 40 ms or 80 ms TTI channel to begin in frame 15 because this would violate the TTI alignment rules given in 3GPP TDD and FDD standards (TS 25.221 and TS 25.222).

The present invention reduces the amount of first interleaver stack substantially. With minimal additional processing overhead, a huge reduction in stack storage capacity is achieved. This is significant because the first interleaver buffer is the largest stack buffer in a TDD WTRU. Instead of the buffer requiring a storage capacity for eight (8) times the maximum amount of coded data that can arrive in 10 ms, the present invention requires a storage capacity of, at most, two (2) times the maximum amount of coded data that can arrive in 10 ms.

The present invention supports shared channels, and supports allocation of transport data among all transport channels in any combination. Even though a WTRU may not support shared channels, it is still possible to reduce the first interleaver buffer stack requirements by approximately 50% since common channels have very small transport data size and throughput requirements compared to the maximum total number of transport bits in aligned TTIs for DCHs and shared channels. The stack dedicated to the shared and common channels shrinks dramatically when the shared channels are taken out. The maximum number of shared channel bits that can be received simultaneously is comparable to the maximum number of DCH bits that can be received simultaneously. Eliminating the support of shared channels allows the use of the maximum number of common channel bits as the limiting factor. Since the maximum number of common channel bits is expected to be much less than the maximum number of shared channel bits, the shared/common channels' portion of stack may be reduced in size.

FIG. 5 is a flowchart of a process 500 including method steps for allocating data in a stack in accordance with the present invention. In step 505, a plurality of data blocks from a plurality of TrCHs are received and interleaved. The interleaved data blocks are stored in a memory stack (i.e., buffer). When storing the interleaved data blocks in the memory stack, a data block having a larger TTI is allocated earlier than a data block having a smaller TTI (step 510). The stored data blocks are read frame by frame. In deallocating the interleaved data blocks, a data block having a smaller TTI is deallocated earlier than a data block having a larger TTI (step 515).

While this invention has been particularly shown and described with reference to preferred embodiments, it will be understood by those skilled in the art that various changes in form and details may be made therein without departing from the scope of the invention described hereinabove.

1. In a wireless communication system, a method for allocating and deallocating data stored in a memory stack, the method comprising:
(a) receiving and interleaving a plurality of data blocks, each data block having a designated transmission timing interval (TTI); and
(b) storing the interleaved data blocks in a memory stack based on the designated TTI of each data block, wherein a data block having a larger TTI is allocated to the memory stack earlier and deallocated from the memory stack later than a data block having a smaller TTI.

2. The method of claim 1 wherein a data block received from a dedicated channel and a data block received from a common/shared channel are stored in separate regions of the memory stack.

3. The method of claim 1 wherein a data block received from an uplink channel and a data block received from a downlink channel are stored in separate regions of the memory stack.

4. The method of claim 1 wherein each data block is allocated for a particular transport channel (TrCH).

5. The method of claim 1 wherein the wireless communication system is a time division duplex (TDD) communication system.

6. The method of claim 1 wherein the wireless communication system is a frequency division duplex (FDD) communication system.

7. The method of claim 1 wherein data blocks having the same TTI are grouped together.

8. In a wireless communication system, an interleaver for allocating and allocating data stored in a memory stack, the interleaver comprising:
(a) a processor for receiving and interleaving a plurality of data blocks, each data block having a designated transmission timing interval (TTI); and
(b) a memory including at least one memory stack, wherein the processor stores the interleaved data blocks in the memory stack based on the TTI of each data block, such that a data block having a larger TTI is allocated to the memory stack earlier and deallocated from the stack later than a data block having a smaller TTI.

9. The interleaver of claim 8 wherein a data block received from a dedicated channel and a data block received from a common/shared channel are stored in separate regions of the memory stack.

10. The interleaver of claim 8 wherein a data block received from an uplink channel and a data block received from a downlink channel are stored in separate regions of the memory stack.

11. The interleaver of claim 8 wherein each data block is allocated for a particular transport channel (TrCH).

12. The interleaver of claim 8 wherein the wireless communication system is a time division duplex (TDD) communication system.

13. The interleaver of claim 8 wherein the wireless communication system is a frequency division duplex (FDD) communication system.

14. The interleaver of claim 8 wherein data blocks having the same TTI are grouped together and are aligned.

15. The interleaver of claim 8 wherein the memory includes a first memory stack for common/shared uplink channels, a second memory stack for dedicated uplink channels, a third memory stack for common/shared downlink channels, and a fourth memory stack for dedicated downlink channels.

16. The interleaver of claim 8 wherein the memory includes a write pointer (WP) and a read pointer (RP) used to indicate the location of a segment in the memory stack for executing writing and reading operations, respectively.

17. The interleaver of claim 8 wherein, as the data blocks are received by the processor, the memory stack is allocated for each frame of a transport channel's TTI for up to eight frames.

18. In a wireless communication system, a wireless transmit/receive unit (WTRU) for allocating and deallocating data stored in a memory stack, the WTRU comprising:
(a) a processor for receiving and interleaving a plurality of data blocks, each data block having a designated transmission timing interval (TTI); and
(b) a memory including at least one memory stack, wherein the processor stores the interleaved data blocks in the memory stack based on the TTI of each data block, such that a data block having a larger TTI is allocated to the memory stack earlier and deallocated from the stack later than a data block having a smaller TTI.

19. The WTRU of claim 18 wherein a data block received from a dedicated channel and a data block received from a common/shared channel are stored in separate regions of the memory stack.

20. The WTRU of claim 18 wherein a data block received from an uplink channel and a data block received from a downlink channel are stored in separate regions of the memory stack.

21. The WTRU of claim 18 wherein each data block is allocated for a particular transport channel (TrCH).

22. The WTRU of claim 18 wherein the wireless communication system is a time division duplex (TDD) communication system.

23. The WTRU of claim 18 wherein the wireless communication system is a frequency division duplex (FDD) communication system.

24. The WTRU of claim 18 wherein data blocks having the same TTI are grouped together and are aligned.

25. The WTRU of claim 18 wherein the memory includes a first memory stack for common/shared uplink channels, a second memory stack for dedicated uplink channels, a third memory stack for common/shared downlink channels, and a fourth memory stack for dedicated downlink channels.

26. The WTRU of claim 18 wherein the memory includes a write pointer (WP) and a read pointer (RP) used to indicate the location of a segment in the memory stack for executing writing and reading operations, respectively.

27. The WTRU of claim 18 wherein, as the data blocks are received by the processor, the memory stack is allocated for each frame of a transport channel's TTI for up to eight frames.

28. In a wireless communication system, a base station for allocating and deallocating data stored in a memory stack, the base station comprising:
(a) a processor for receiving and interleaving a plurality of data blocks, each data block having a designated transmission timing interval (TTI); and
(b) a memory including at least one memory stack, wherein the processor stores the interleaved data blocks in the memory stack based on the TTI of each data block, such that a data block having a larger TTI is allocated to the memory stack earlier and deallocated from the stack later than a data block having a smaller TTI.

29. The base station of claim 28 wherein a data block received from a dedicated channel and a data block received from a common/shared channel are stored in separate regions of the memory stack.

30. The base station of claim 28 wherein a data block received from an uplink channel and a data block received from a downlink channel are stored in separate regions of the memory stack.

31. The base station of claim 28 wherein each data block is allocated for a particular transport channel (TrCH).

32. The base station of claim 28 wherein the wireless communication system is a time division duplex (TDD) communication system.

33. The base station of claim 28 wherein the wireless communication system is a frequency division duplex (FDD) communication system.

34. The base station of claim 28 wherein data blocks having the same TTI are grouped together and are aligned.

35. The base station of claim 28 wherein the memory includes a first memory stack for common/shared uplink channels, a second memory stack for dedicated uplink channels, a third memory stack for common/shared downlink channels, and a fourth memory stack for dedicated downlink channels.

36. The base station of claim 28 wherein the memory includes a write pointer (WP) and a read pointer (RP) used to indicate the location of a segment in the memory stack for executing writing and reading operations, respectively.

37. The base station of claim 28 wherein, as the data blocks are received by the processor, the memory stack is allocated for each frame of a transport channel's TTI for up to eight frames.

38. In a wireless communication system, an integrated circuit (IC) for allocating and deallocating data stored in a memory stack, the IC comprising:
(a) a processor for receiving and interleaving a plurality of data blocks, each data block having a designated transmission timing interval (TTI); and
(b) a memory including at least one memory stack, wherein the processor stores the interleaved data blocks in the memory stack based on the TTI of each data block, such that a data block having a larger TTI is allocated to the memory stack earlier and deallocated from the stack later than a data block having a smaller TTI.

39. The IC of claim 38 wherein a data block received from a dedicated channel and a data block received from a common/shared channel are stored in separate regions of the memory stack.

40. The IC of claim 38 wherein a data block received from an uplink channel and a data block received from a downlink channel are stored in separate regions of the memory stack.

41. The IC of claim 38 wherein each data block is allocated for a particular transport channel (TrCH).

42. The IC of claim 38 wherein the wireless communication system is a time division duplex (TDD) communication system.

43. The IC of claim 38 wherein the wireless communication system is a frequency division duplex (FDD) communication system.

44. The IC of claim 38 wherein data blocks having the same TTI are grouped together and are aligned.

45. The IC of claim 38 wherein the memory includes a first memory stack for common/shared uplink channels, a second memory stack for dedicated uplink channels, a third memory stack for common/shared downlink channels, and a fourth memory stack for dedicated downlink channels.

46. The IC of claim 38 wherein the memory includes a write pointer (WP) and a read pointer (RP) used to indicate the location of a segment in the memory stack for executing writing and reading operations, respectively.

47. The IC of claim 38 wherein, as the data blocks are received by the processor, the memory stack is allocated for each frame of a transport channel's TTI for up to eight frames.
